(19) United States
(12) Patent Application Publication
(10) Pub. No.: US 2024/0394796 A1
(43) Pub. Date: Nov. 28, 2024

(54) Investment Service System For Mitigating Investment Risks In Start-Ups Using A Blockchain Network

(71) Applicant: Pitchmatter Inc, Newark, DE (US)

(72) Inventor: Joseph Chacko, Newark, DE (US)

(21) Appl. No.: 18/788,159

(22) Filed: Jul. 30, 2024

(51) Int. Cl. G06Q 40/06

(52) U.S. Cl. CPC G06Q 40/06

(57) ABSTRACT

A comprehensive system and method for managing investments in start-ups using blockchain technology, DAO principles, and deflationary tokenomics to reduce risk, enhance investor returns, and ensure governance transparency through decentralized decision-making. An investment service system comprises one or more computing servers, each of the computing servers comprising one or more processors and a memory coupled to the processors comprising instructions executable by the processors. The investment service system is in communication with one or more investor computing devices and one or more start-up computing devices through one or more networks. The investment service system is configured to connect an investor with at least one start-up. The investment service system comprise a service wallet, a tokenized module, a transaction commission module, and a ledger database.

### FIELD OF THE INVENTION

The present disclosure relates generally blockchain-powered investment ecosystems, and more particularly to a comprehensive system and method for managing investments in start-ups using blockchain technology, decentralized autonomous organization (DAO) principles, and deflationary tokenomics to reduce risk, enhance investor returns, and ensure governance transparency through decentralized decision-making.

### BACKGROUND

Start-up's, despite their potential for innovation, face a stark reality of high failure rates, estimated 70% to 90% within their initial stages. This significant failure rate impacts multiple stakeholders within the entrepreneurial ecosystem, each facing distinct risks and consequences.

Investors, spanning from individual angels to institutional venture capitalists, bear substantial risks when start-ups fail. The loss of invested capital not only affects their financial portfolios but also diminishes confidence in future start-up investments. This uncertainty can dampen overall investment activity within the start-up ecosystem as investors adopt more cautious strategies in response to volatile outcomes.

Founders experience profound personal and professional setbacks from start-up failures. Beyond financial loss, failure undermines their credibility and may hinder future entrepreneurial pursuits. Employees also suffer, facing job losses and financial instability, having often traded stable careers for the potential rewards of start-up equity.

Start-up failures reverberate through broader stakeholder networks. Suppliers face potential financial losses, while customers and partners may experience disruptions in service or collaboration agreements. These failures can strain strategic alliances and disrupt established business networks.

Current investment strategies often fail to adequately address the unique risks associated with start-ups. Traditional due diligence processes may overlook critical factors like market fit and competitive dynamics, leaving investors vulnerable to unforeseen challenges and operational failures.

There is an urgent need for innovative solutions to mitigate these risks effectively and foster a supportive environment for start-up growth. These solutions should integrate enhanced transparency, robust governance frameworks, and advanced technologies such as blockchain and DAO principles. By doing so, they aim to minimize failure rates, reward responsible entrepreneurship, and create a more equitable landscape where stakeholders can actively participate and benefit from entrepreneurial endeavors.

Therefore, there is a need for a comprehensive system and method for managing investments in start-ups using blockchain technology, DAO principles, and deflationary tokenomics to reduce risk, enhance investor returns, and ensure governance transparency through decentralized decision-making.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a comprehensive system and method for managing investments in start-ups using blockchain technology, DAO principles, and deflationary tokenomics to reduce risk, enhance investor returns, and ensure governance transparency through decentralized decision-making.

In one embodiment herein, an investment service system for mitigating investment risks in start-ups using a blockchain network. The investment service system comprises one or more computing servers, each of the computing servers comprising one or more processors and a memory coupled to the processors comprising instructions executable by the processors. The blockchain network is configured for facilitating secure and transparent transactions.

The investment service system is in communication with one or more investor computing devices and one or more start-up computing devices through one or more networks. The network may represent any one or more wired or wireless networks, such as a Wi-Fi network, a cellular network, or the like. The network comprises at least one of Bitcoin network, and the Ethereum network, thereof.

The investment service system is configured to connect an investor with at least one start-up. The investment service system is configured to receiving, from an investor computing device associated with the investor, a request for investment associated with a transaction between the investor and the at least one start-up. The transaction comprises a payment amount.

In another embodiment, when an investor and the at least one start-up enter into an electronic payment transaction, the transaction may be processed by electronically transferring funds from a financial account associated with the investor to a financial account associated with the at least one start-up.

The investment service system comprise a service wallet, a tokenized module, a transaction commission module, and a ledger database. The service wallet is configured to calculate and collect a service amount from the at least one start-up based on funds raised by the at least one start-up. The tokenized module is configured to generate and issue shield tokens based on the collected service amount and a predetermined market value of the shield tokens.

In one embodiment, the tokenized module is a tokenized ecosystem that is configured to manage the issuance and distribution of tokens representing equity or agreed benefits in start-ups and the shield tokens.

The transaction commission module is operable on the blockchain network. The transaction commission module is configured to implement a lock-up period for the issued shield tokens, thereby restricting transfer of the issued shield tokens for a predetermined duration. The transaction commission module is configured to implement a vesting period for the issued shield tokens, gradually releasing the issued shield tokens to the investor over a predetermined timeframe. The transaction commission module is configured to charge a transaction commission amount on all transactions within the tokenized module.

The transaction commission module configured to distribute a first portion of the transaction commission amount as rewards to token holders, allocate a second portion of the transaction commission amount to a liquidity pool to facilitate token trading, and permanently burn a remaining portion of the transaction commission amount to reduce the total supply of the shield tokens. The transaction commission amount comprises 10% of all transactions within the tokenized module. The first portion of the transaction commission amount comprises at least 5% of transaction commission amount. The second portion of the transaction commission amount comprises at least 2.5% of transaction commission amount.

The transaction commission module utilizes a deflationary mechanism for to manage the supply and value of the shield tokens. The remaining portion of the transaction commission amount comprises at least 2.5% of transaction commission amount to reduce the total supply of shield tokens.

A decentralized autonomous organization (DAO) governance system is configured to allow token holders to participate in decision-making processes related to the tokenized module 110.

The investment service system comprises the ledger database for recording asset-related transactions to the investor of the investment service system. The ledger database comprises an investor balance associated with the investor and a service balance associated with the investment service system.

In another embodiment herein, a method for mitigating investment risks in start-ups using the blockchain network. The method comprise, connecting, by the investment service system, an investor with at least one start-up. The method comprise, receiving, by the investment service system from an investor computing device associated with the investor, a request for investment associated with a transaction between the investor and the at least one start-up, wherein the transaction comprises a payment amount.

The method comprise, calculating and collecting, by the investment service system, a service amount from the at least one start-up based on funds raised by the at least one start-up. The method comprise, generating and issuing, by a tokenized module of the investment service system, shield tokens based on the collected service amount and a predetermined market value of the shield tokens.

The method comprise, implementing, by the investment service system, a lock-up period for the issued shield tokens, thereby restricting transfer of the issued shield tokens for a predetermined duration. The method comprise, implementing, by the investment service system, a vesting period for the issued shield tokens, gradually releasing the issued shield tokens to the investor over a predetermined timeframe.

The method comprise, charging, the investment service system, transaction commission on all transactions within the tokenized module. The method comprise, facilitating, through a decentralized autonomous organization (DAO) governance system, decision-making processes related to the tokenized module, wherein token holders participate in voting on proposals.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIGS. 1A and 1B refer to block diagrams of an investment service system for mitigating investment risks in start-ups using a blockchain network, in accordance with embodiments of the invention.

FIG. 2 refer to a flowchart of a method for mitigating investment risks in start-ups using the blockchain network, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

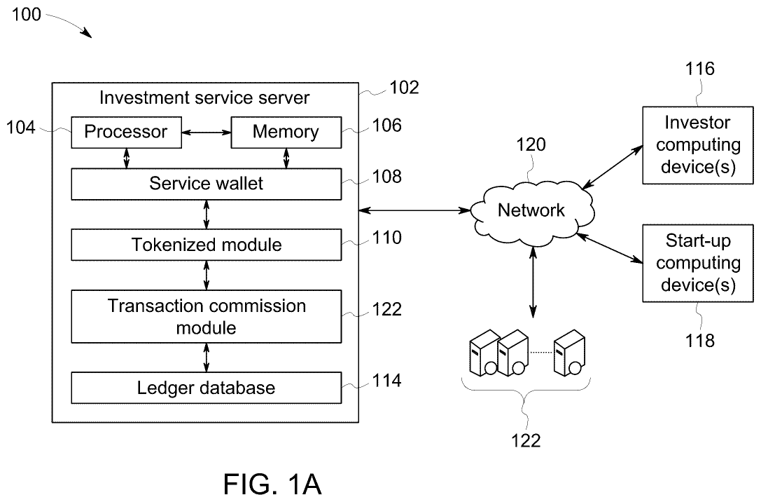

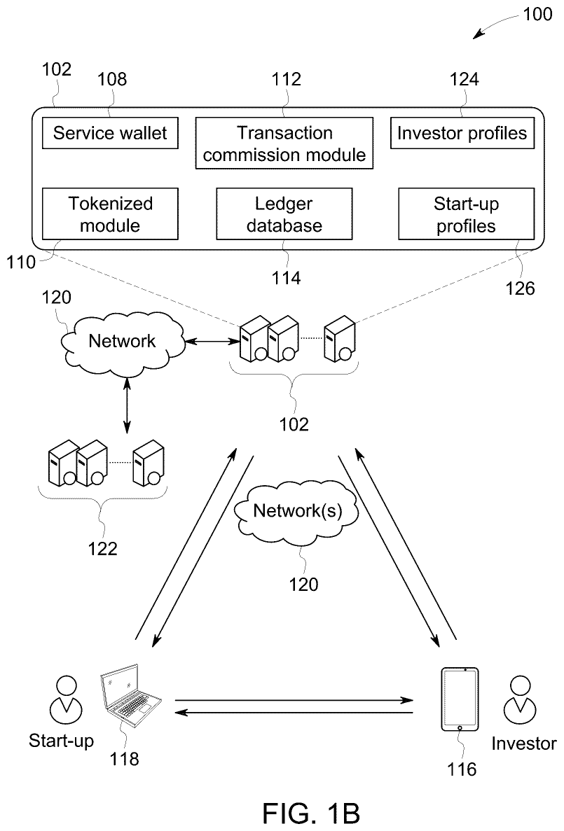

FIGS. 1A and 1B refer to a block diagram of an investment service system 100 for mitigating investment risks in start-ups using a blockchain network. The investment service system 100 comprises one or more computing servers 102, each of the computing servers 102 comprising one or more processors 104 and a memory 106 coupled to the processors 104 comprising instructions executable by the processors 104. The blockchain network is configured for facilitating secure and transparent transactions.

The investment service system 100 is in communication with one or more investor computing devices 116 and one or more start-up computing devices 118 through one or more networks 120. The network 120 may represent any one or more wired or wireless networks, such as a Wi-Fi network, a cellular network, or the like. The network 120 comprises at least one of Bitcoin network, and the Ethereum network, thereof.

In another embodiment, the computing servers 102 may also communicate with one or more computing devices of one or more banks, processing/acquiring services, or the like over the network 120.

The investment service system 100 is configured to connect an investor with at least one start-up. The investment service system 100 is configured to receiving, from an investor computing device 116 associated with the investor, a request for investment associated with a transaction between the investor and the at least one start-up. The transaction comprises a payment amount.

In another embodiment, when an investor and the at least one start-up enter into an electronic payment transaction, the transaction may be processed by electronically transferring funds from a financial account associated with the investor to a financial account associated with the at least one start-up.

The investment service system 100 comprise a service wallet 108, a tokenized module 110, a transaction commission module 112, and a ledger database 114. The service wallet 108 is configured to calculate and collect a service amount from the at least one start-up based on funds raised by the at least one start-up. The tokenized module 110 is configured to generate and issue shield tokens based on the collected service amount and a predetermined market value of the shield tokens. In one embodiment, the service amount is success fees.

In one embodiment, the investment service system 100 comprises smart contacts for disbursing the funds raised by the at least one start-up from the service wallet 108. Automated execution of agreements through smart contracts reduces administrative overhead and ensures compliance with investment terms.

In one embodiment, the tokenized module 110 is a tokenized ecosystem that is configured to manage the issuance and distribution of tokens representing equity or agreed benefits in start-ups and the shield tokens.

The transaction commission module 112 is operable on the blockchain network. The transaction commission module 112 is configured to implement a lock-up period for the issued shield tokens, thereby restricting transfer of the issued shield tokens for a predetermined duration. The transaction commission module 112 is configured to implement a vesting period for the issued shield tokens, gradually releasing the issued shield tokens to the investor over a predetermined timeframe. The transaction commission module 112 is configured to charge a transaction commission amount on all transactions within the tokenized module 110.

The transaction commission module configured to distribute a first portion of the transaction commission amount as rewards to token holders, allocate a second portion of the transaction commission amount to a liquidity pool to facilitate token trading, and permanently burn a remaining portion of the transaction commission amount to reduce the total supply of the shield tokens. The transaction commission amount comprises 10% of all transactions within the tokenized module 110. The first portion of the transaction commission amount comprises at least 5% of transaction commission amount. The second portion of the transaction commission amount comprises at least 2.5% of transaction commission amount.

The transaction commission module 112 utilizes a deflationary mechanism for to manage the supply and value of the shield tokens. The remaining portion of the transaction commission amount comprises at least 2.5% of transaction commission amount to reduce the total supply of shield tokens.

In one embodiment, the deflationary mechanism includes burning a portion of shield tokens during transactions, ensures a limited supply of shield tokens. This scarcity leads to an increase in shield tokens value over time. Regular burning of the shield tokens as part of transaction fees ensures continuous reduction in shield tokens supply, driving up the value of the remaining tokens. The distribution of transaction commissions as rewards incentivizes token holders to participate in and support the ecosystem.

A decentralized autonomous organization (DAO) governance system 122 is configured to allow token holders to participate in decision-making processes related to the tokenized module 110.

In one embodiment, The DAO governance system 122 is configured to allow token holders to participate in decision-making processes, promoting a sense of ownership and community engagement. Each governance action and decision are recorded on the blockchain network, ensuring transparency and accountability. The DAO governance system 122 encourages wide participation from token holders, leading to more democratic and representative governance of the ecosystem.

The investment service system 100 integrates investment management, token issuance, and the DAO governance system 122, providing a seamless user experience.

The investment service system 100 comprises the ledger database 114 for recording asset-related transactions to the investor of the investment service system 100. The ledger database 114 comprises an investor balance associated with the investor and a service balance associated with the investment service system 100.

Referring to FIG. 1B, the computing servers 102 comprises investor profiles 124, and start-up profiles 126. The investor profiles 124 comprise information about one or more investors using the investment service system 100. The start-up profiles 126 comprise information about one or more start-ups using the investment service system 100. Each start-up or investor may otherwise be called a user of the investment service system 100. A particular user may be a start-up, an investor, or either depending on the use case.

In another embodiment, while the investor profiles 124 may store indications of user preferences, the start-up profiles 126 may store information associated with respective ones of the start-ups. For instance, the start-up profiles 126 may indicate history of investment associated with a transaction between the investors and the start-up, wherein transaction comprises a payment amount, data related to funds raised by the start-up, the service amount paid to the investment service system 100, the shield tokens based on the collected service amount, the predetermined market value of the shield tokens, a type of business of the start-up (e.g., restaurant, coffee shop, retail store, etc.), a geographical location of the start-up, and the like.

In some embodiments, the investment service system 100 may store the investor profiles 124 for each of a plurality of investors. The investor profiles 124 may include investor data that may include investor-identifying information (name, contact information, etc.), a transaction log including records of past transactions involving the investment service system 100 by the investor, information regarding linked accounts (credit card information, bank account information, etc.), information regarding services utilized by the investor profiles 124 (e.g., a mobile wallet application). The investor data may further comprise information associated with one or more social or peer-to-peer contacts of a user (e.g., friends, family members). The information may comprise at least part of the profile information of such contacts.

In some embodiments, the investor profile 124 may also include a ledger for any accounts managed by the investment service system 100 on behalf of the investor. It will be appreciated that investors having accounts managed by the payment service is an aspect of the technology that enables technical advantages of increased processing speed and improved security. For example, the investor profile 124 may include a currency ledger. The currency ledger may store a balance for each of one or more currencies that the investor owns. The investor profile 124 may also include a securities ledger. The securities ledger may store a balance for each of one or more security assets (e.g., stocks, bonds, futures) that the investor owns. The currency ledger and the securities ledger may utilize any suitable data structure. Various ledgers associated with a particular investor may be stored all together, in groups, or separately. As another example and not by way of limitation, the currency ledger and the securities ledger may be logical ledgers. The associated with the ledgers may all be saved in a single file, data set, or database. In other words, an investor's ownership interest in a plurality of types of assets (e.g., fiat currency, cryptocurrency, security assets) may all be recorded in a composite ledger or be separated recorded in a plurality of ledgers.

In another embodiment, the ledger database 114 is configured with stored all together, in groups, or separately various ledgers associated with a particular investor.

In one embodiment, the investment service system 100 is configured for mitigating investment risks in start-ups using blockchain technology and Decentralized Autonomous Organization (DAO) principles. The investment service system 100 provides a multi-layered protection mechanism for investors by leveraging a tokenized ecosystem where equity and cash reserves grow while maintaining a limited token supply. The investment service system 100 incorporates a deflationary mechanism that reduces the total number of tokens over time, enhancing their value and utility within the tokenized ecosystem.

Investors in start-ups receive equity or agreed benefits directly from the start-ups in which they invest. Additionally, investors receive shield tokens from the investment service system 100 as an added layer of protection and incentive. The shield tokens are distributed based on the service amount collected by the investment service system 100 from the start-ups, calculated according to the market value of the shield tokens. The shield tokens are subject to the lock-up period and gradual release to prevent market dumping. Furthermore, a transaction commission is implemented, with a portion distributed as rewards to token holders, a portion added to a liquidity pool, and a portion permanently burned to ensure token scarcity.

In one embodiment, the token holders participate in governance decisions through a DAO structure. Decisions may include voting on platform upgrades, new features, and other ecosystem-related matters.

In another embodiment, an investor can submit a proposal for disbursement of funds from the DAO. The DAO can be associated with a set of voting share shield tokens that can be provided to the investors according to their contributions to the DAO. When investors use their shield tokens to vote on the proposal, a smart contract deployed to a distributed ledger for the DAO can review the votes and the corresponding tokens to determine if the proposal is approved. If so, funds from the DAO can be provided to content creators for the creation of digital objects that can be published to a digital object marketplace. Financial distributions resulting from the sale of these digital objects can be automatically provided to investors according to their respective voting shield tokens.

In one embodiment, the issued shield tokens are subject to a 36-month cliff period, followed by a vesting period of 50 months to prevent market dumping. The shield tokens are distributed to the digital wallets but remain locked until the end of the cliff period.

This approach not only provides investors with additional security but also offers benefits to token holders through DAO governance and participation in the ecosystem's growth. The invention includes an annual StartupXPO event for on-boarding start-ups, where the investment service system 100 takes equity in services and investments and charges a success fee on funds raised. This innovative system aims to protect investors, promote start-up success, and create a sustainable and valuable token ecosystem.

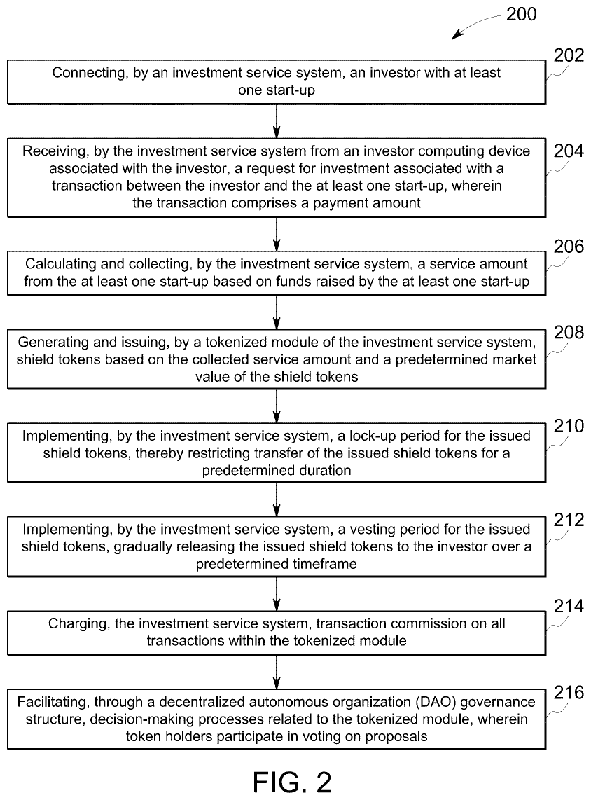

FIG. 2 refers to a flow chart 200 of a method for mitigating investment risks in start-ups using the blockchain network. The method comprise, connecting, by the investment service system 100, an investor with at least one start-up, as depicted in step 202. The method comprise, receiving, by the investment service system 100 from an investor computing device 116 associated with the investor, a request for investment associated with a transaction between the investor and the at least one start-up, wherein the transaction comprises a payment amount, as depicted in step 204.

The method comprise, calculating and collecting, by the investment service system 100, a service amount from the at least one start-up based on funds raised by the at least one start-up, as depicted in step 206. The method comprise, generating and issuing, by a tokenized module 110 of the investment service system 100, shield tokens based on the collected service amount and a predetermined market value of the shield tokens, as depicted in step 208.

The method comprise, implementing, by the investment service system 100, a lock-up period for the issued shield tokens, thereby restricting transfer of the issued shield tokens for a predetermined duration, as depicted in step 210. The method comprise, implementing, by the investment service system 100, a vesting period for the issued shield tokens, gradually releasing the issued shield tokens to the investor over a predetermined timeframe, as depicted in step 212.

The method comprise, charging, the investment service system 100, transaction commission on all transactions within the tokenized module, as depicted in step 214. The method comprise, facilitating, through a decentralized autonomous organization (DAO) governance system 122, decision-making processes related to the tokenized module 110, wherein token holders participate in voting on proposals, as depicted in step 216.

In another embodiment, the blockchain network provides an immutable ledger of all transactions, ensuring transparency and trust among investors and start-ups. The decentralized nature of blockchain network enhances security, reducing the risk of fraud and unauthorized access.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. An investment service system for mitigating investment risks in start-ups using a blockchain network, comprising:
one or more computing servers, each of the computing servers comprising one or more processors and a memory coupled to the processors comprising instructions executable by the processors, the processors being operable when executing the instructions to:
connect an investor with at least one start-up;
receiving, from an investor computing device associated with the investor, a request for investment associated with a transaction between the investor and the at least one start-up, wherein the transaction comprises a payment amount, wherein the an investor computing device is in communication with the investment service system through a network;
calculate and collect, by a service wallet, a service amount from the at least one start-up based on funds raised by the at least one start-up;
generate and issue, by a tokenized module, shield tokens based on the collected service amount and a predetermined market value of the shield tokens;
implement a lock-up period for the issued shield tokens, thereby restricting transfer of the issued shield tokens for a predetermined duration;
implement a vesting period for the issued shield tokens, gradually releasing the issued shield tokens to the investor over a predetermined timeframe; and
charge, by a transaction commission module, a transaction commission amount on all transactions within the tokenized module;
a decentralized autonomous organization (DAO) governance system configured to allow token holders to participate in decision-making processes related to the tokenized module.

2. The investment service system of claim 1, wherein the transaction commission module is operable on the blockchain network, configured to:
distribute a first portion of the transaction commission amount as rewards to token holders;
allocate a second portion of the transaction commission amount to a liquidity pool to facilitate token trading; and
permanently burn a remaining portion of the transaction commission amount to reduce the total supply of the shield tokens.

3. The investment service system of claim 1, wherein the transaction commission amount comprises 10% of all transactions within the tokenized module.

4. The investment service system of claim 2, wherein the first portion of the transaction commission amount comprises at least 5% of transaction commission amount.

5. The investment service system of claim 2, wherein the second portion of the transaction commission amount comprises at least 2.5% of transaction commission amount.

6. The investment service system of claim 2, wherein the remaining portion of the transaction commission amount comprises at least 2.5% of transaction commission amount.

7. The investment service system of claim 1, wherein the blockchain network is configured for facilitating secure and transparent transactions.

8. The investment service system of claim 1, wherein the service amount comprises 5-10% of the funds raised by the start-ups.

9. The investment service system of claim 1, wherein the investment service system comprises a ledger database for recording asset-related transactions to the investor of the investment service system, wherein the ledger database comprises an investor balance associated with the investor and a service balance associated with the investment service system.

10. The investment service system of claim 1, wherein the investment service system comprises smart contacts for disbursing the funds raised by the at least one start-up from the service wallet.

11. A method for mitigating investment risks in start-ups using a blockchain network, comprising:
connecting, by an investment service system, an investor with at least one start-up;
receiving, by the investment service system from an investor computing device associated with the investor, a request for investment associated with a transaction between the investor and the at least one start-up, wherein the transaction comprises a payment amount;
calculating and collecting, by the investment service system, a service amount from the at least one start-up based on funds raised by the at least one start-up;
generating and issuing, by a tokenized module of the investment service system, shield tokens based on the collected service amount and a predetermined market value of the shield tokens;
implementing, by the investment service system, a lock-up period for the issued shield tokens, thereby restricting transfer of the issued shield tokens for a predetermined duration;
implementing, by the investment service system, a vesting period for the issued shield tokens, gradually releasing the issued shield tokens to the investor over a predetermined timeframe;
charging, the investment service system, transaction commission on all transactions within the tokenized module; and
facilitating, through a decentralized autonomous organization (DAO) governance system, decision-making processes related to the tokenized module, wherein token holders participate in voting on proposals.

12. The method of claim 11, wherein the investment service system comprises a transaction commission module that is operable on the blockchain network, configured to:
distribute a first portion of the transaction commission amount as rewards to token holders;
allocate a second portion of the transaction commission amount to a liquidity pool to facilitate token trading; and
permanently burn a remaining portion of the transaction commission amount to reduce the total supply of the shield tokens.

13. The method of claim 11, wherein the transaction commission amount comprises 10% of c all transactions within the tokenized module.

14. The method of claim 12, wherein the first portion of the transaction commission amount comprises at least 5% of transaction commission amount.

15. The method of claim 12, wherein the second portion of the transaction commission amount comprises at least 2.5% of transaction commission amount.

16. The method of claim 12, wherein the remaining portion of the transaction commission amount comprises at least 2.5% of transaction commission amount.

17. The method of claim 11, wherein the blockchain network is configured for facilitating secure and transparent transactions.

18. The method of claim 11, wherein the service amount comprises 5-10% of the funds raised by the start-ups.

19. The method of claim 11, wherein the investment service system comprises a ledger database for recording asset-related transactions to the investor of the investment service system, wherein the ledger database comprises an investor balance associated with the investor and a service balance associated with the investment service system.

20. The method of claim 11, wherein the investment service system comprises smart contacts for disbursing the funds raised by the at least one start-up from the service wallet.
